(19) United States
(12) Patent Application Publication
(10) Pub. No.: US 2024/0195072 A1
(43) Pub. Date: Jun. 13, 2024

(54) ANTENNA AND SUBSTRATE INCLUDING EMBEDDED ANTENNA

(71) Applicant: Samsung Electro-Mechanics Co., Ltd., Suwon-si (KR)

(72) Inventors: Woo-Jung CHOI, Suwon-si (KR); Dooil KIM, Suwon-si (KR)

(73) Assignee: Samsung Electro-Mechanics Co., Ltd., Suwon-si (KR)

(21) Appl. No.: 18/226,358

(22) Filed: Jul. 26, 2023

(30) Foreign Application Priority Data
Dec. 8, 2022 (KR) 10-2022-0170882

(51) Int. Cl. H01Q 9/04; H01Q 1/38

(52) U.S. Cl. CPC H01Q 9/0485; H01Q 1/38

(57) ABSTRACT

An antenna includes a plurality of dielectric units arranged along a first direction and a second direction different from the first direction, and an interface layer disposed between the dielectric units and attached to two adjacent dielectric units among the plurality of dielectric units.

### CROSS-REFERENCE TO RELATED APPLICATIONS

This application claims the benefit under 35 USC 119(a) of Korean Patent Application No. 10-2022-0170882 filed on Dec. 8, 2022, in the Korean Intellectual Property Office, the entire contents of which are incorporated herein by reference for all purposes.

### BACKGROUND

### 1. Field

The present disclosure relates to an antenna and a substrate in which the antenna is embedded.

### 2. Description of Related Art

The development of wireless communication systems has greatly changed peoples' lifestyles over the past 20 years. Advanced mobile systems with gigabit data rates per second are needed to support wireless applications such as multimedia devices, Internet of Things, and intelligent transportation systems.

Recently, as an electronic device equipped with an antenna has become thinner, a size of an antenna module for mobile millimeter wave (mmWave) and higher subterahertz frequency needs to be made smaller.

As such, as the size of the antenna module decreases, performance such as antenna gain and bandwidth may deteriorate.

The above information disclosed in this Background section is only for enhancement of understanding of the background of the disclosure of this application, and therefore it may contain information that does not constitute prior art that is already known to a person of ordinary skill in the art.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an antenna includes a plurality of dielectric units arranged along a first direction and a second direction different from the first direction; and an interface layer disposed between the dielectric units and attached to two adjacent dielectric units among the plurality of dielectric units.

The dielectric units may be arranged in an array form along the first direction and the second direction.

The dielectric units may include a ceramic material.

The interface layer may have an adhesive property.

The interface layer may include a polymer.

The dielectric units may have a rectangular parallelepiped shape.

All of the dielectric units may have substantially a same size.

The dielectric units may include a plurality of first dielectric units each having a first size, and a plurality of second dielectric units each having a second size different from the first size.

The first dielectric units and the second dielectric units may be alternately disposed in rows along the first direction.

One side of each of the first dielectric units and the second dielectric units in each of the rows may be aligned in the second direction with an imaginary line along the first direction.

The first dielectric units and the second dielectric units also may be alternately disposed in rows along the second direction.

The interface layer may be disposed between dielectric units adjacent to each other along the second direction among the dielectric units, and may have a shape extending along the first direction.

The interface layer may include a portion disposed between dielectric units adjacent to each other along the first direction among the dielectric units and having a shape extending along the second direction.

In another general aspect, an antenna embedded substrate includes a substrate including a plurality of through via layers and an opening; an antenna disposed in the opening of the substrate, the antenna including a plurality of dielectric units arranged along a first direction and a second direction different from the first direction, and an interface layer disposed between the dielectric units and attached to two adjacent dielectric units among the dielectric units; an insulating layer disposed on a first surface of the substrate; a plurality of via layers disposed in the insulating layer; and a plurality of wiring layers connected to the via layers.

A dielectric constant of each of the dielectric units may be greater than a dielectric constant of the substrate.

The dielectric units may include a ceramic material.

The interface layer may have an adhesive property.

The interface layer may include a polymer.

The interface layer may be disposed between dielectric units adjacent to each other along the second direction among the dielectric units, and may have a shape extending along the first direction.

The interface layer may include a portion disposed between dielectric units adjacent to each other along the first direction among the dielectric units and having a shape extending along the second direction.

In another general aspect, an antenna includes a plurality of dielectric units arranged along a first direction and a second direction substantially perpendicular to the first direction; and an interface layer disposed between the dielectric units and fixing the dielectric units in place.

The dielectric units may include a ceramic material, and the interface layer may include a polymer material having an adhesive property.

The interface layer may be disposed between rows of dielectric units that are adjacent to each other along the second direction among the dielectric units, and may be continuous along the first direction between the rows of dielectric units that are adjacent to each other in the second direction.

The interface layer may be further disposed between rows of dielectric units that are adjacent to each other along the first direction among the dielectric units, and may be continuous along the second direction between the rows of dielectric units that are adjacent to each other in the first direction.

The dielectric units may include a plurality of first dielectric units each having a first size, and a plurality of second dielectric units each having a second size different from the first size.

The first dielectric units and the second dielectric units may be alternately disposed in rows along the first direction.

The first dielectric units may be disposed in some rows along the second direction, and the second dielectric units may be disposed in other rows along the second direction.

The first dielectric units and the second dielectric units also may be alternately disposed in rows along the second direction.

Other features and aspects will be apparent from the following detailed description, the drawings, and the claims.

### BRIEF DESCRIPTION OF THE DRAWINGS

FIG. 1 illustrates a perspective view of an antenna unit according to an embodiment.

FIG. 2 and FIG. 3 illustrate views for describing a manufacturing method of the antenna unit of FIG. 1 according to an embodiment.

FIG. 4 illustrates a perspective view of an antenna unit according to another embodiment.

FIG. 5 illustrates an exploded perspective view of the antenna unit of FIG. 4 according to another embodiment.

FIG. 6 illustrates a perspective view of an antenna unit according to another embodiment.

FIG. 7 illustrates a perspective view of an antenna unit according to another embodiment.

FIG. 8 illustrates a perspective view of an antenna unit according to another embodiment.

FIG. 9 illustrates a top plan view of an antenna unit according to another embodiment.

FIG. 10 illustrates a top plan view of an antenna unit according to another embodiment.

FIG. 11 illustrates a top plan view of an antenna unit according to another embodiment.

FIG. 12 illustrates a cross-sectional view showing a substrate having an embedded antenna according to an embodiment.

FIG. 13 to FIG. 23 illustrate cross-sectional views showing a manufacturing method of the substrate with an embedded antenna of FIG. 12 according to an embodiment.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Further, since sizes and thicknesses of constituent members shown in the accompanying drawings are arbitrarily given for better understanding and ease of description, this disclosure is not limited to the illustrated sizes and thicknesses. In the drawings, the thicknesses of layers, films, panels, regions, etc., are exaggerated for clarity. In the drawings, for better understanding and ease of description, the thicknesses of some layers and areas are exaggerated.

Further, throughout the specification, the phrase “in a plan view” means when an object is viewed from above, and the phrase “in a cross-sectional view” means when a cross-section taken by vertically cutting an object is viewed from the side.

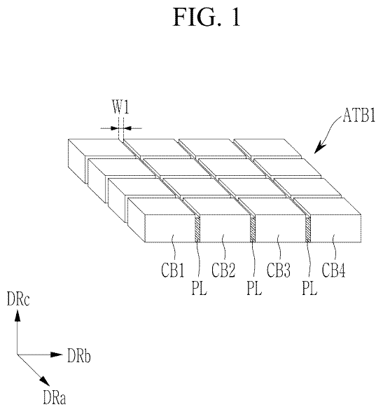

FIG. 1 illustrates a perspective view of an antenna unit according to an embodiment.

Referring to FIG. 1, according to an embodiment, an antenna unit ATB1 may include a plurality of first dielectric units CB1 arranged side by side in a first row along a first direction DRa, a plurality of second dielectric units CB2 arranged side by side in second row along the first direction DRa, a plurality of third dielectric units CB3 arranged side by side in a third row along the first direction DRa, and a plurality of fourth dielectric units CB4 arranged side by side in a fourth row along the first direction DRa.

The first row of the first dielectric units CB1, the second row of the second dielectric units CB2, the third row of the third dielectric units CB3, and the fourth row of the fourth dielectric units CB4 may be sequentially arranged side by side along a second direction DRb.

An interface layer PL disposed along the first direction DRa is disposed between the first dielectric units CB1 and the second dielectric units CB2, between the second dielectric units CB2 and the third dielectric units CB3, and between the third dielectric units CB3 and the fourth dielectric units CB4.

The dielectric units CB1, CB2, CB3, and CB4 may have, e.g., a rectangular parallelepiped shape. The dielectric units CB1, CB2, CB3, and CB4 may include a ceramic material.

The interface layer PL may include a polymer material, and may have an adhesive property.

A distance between the first dielectric units CB1 and the second dielectric units CB2, a distance between the second dielectric units CB2 and the third dielectric units CB3, and a distance between the third dielectric units CB3 and the fourth dielectric units CB4, arranged along the second direction DRb, may be equal to a first width W1 of the interface layer PL.

As such, the antenna unit ATB1 according to the present embodiment may include the dielectric units CB1, CB2, CB3, and CB4 arranged in an array form along the first and second directions DRa and DRb, and the interface layer PL disposed between the dielectric units CB1, CB2, CB3, and CB4. Accordingly, a performance of the antenna unit ATB1 may be improved while reducing a size of the antenna unit ATB1 compared to a case where the dielectric units CB1, CB2, CB3, and CB4 are arranged along only one direction.

Although the antenna unit ATB1 of the embodiment of FIG. 1 is illustrated as including four of each of the dielectric units CB1, CB2, CB3, and CB4 arranged along the first and second directions DRa and DRb, the embodiment is not limited thereto, and a number of each of the dielectric units arranged along the first and second directions DRa and DRb may vary.

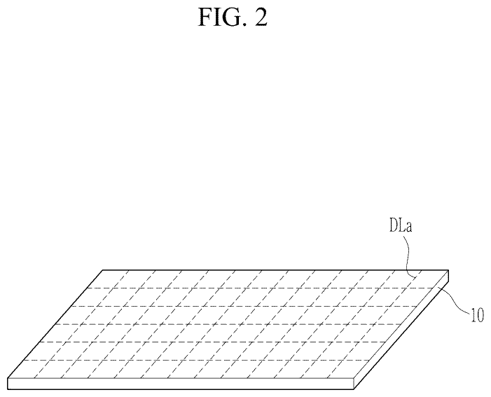

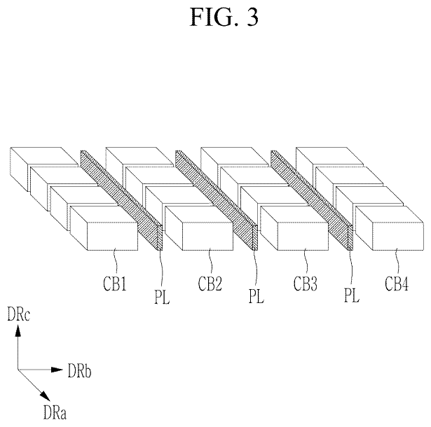

FIG. 2 and FIG. 3 illustrate views for describing a manufacturing method of the antenna unit of FIG. 1 according to an embodiment.

First, as illustrated in FIG. 2, each of the dielectric units CB1, CB2, CB3, and CB4 may be formed by cutting a dielectric layer 10 according to a size of each of the dielectric units CB1, CB2, CB3, and CB4 as shown by a dividing line DLa in FIG. 2. Accordingly, side surfaces extending along the first direction DRa, the second direction DRb, and a third direction DRc, that is, four pairs of side surfaces, may be formed to be connected to each other smoothly without steps so as to be disposed on a same plane.

Then, as illustrated in FIG. 3, the antenna unit ATB1 according to the embodiment illustrated in FIG. 1 may be formed by arranging the first dielectric units CB1 side by side in the first row along the first direction DRa, arranging the second dielectric units CB2 side by side in the second row along the first direction DRa, arranging the third dielectric units CB3 side by side in the third row along the first direction DRa, and arranging the fourth dielectric units CB4 side by side in the fourth row along the first direction DRa, and forming the interface layer PL having the adhesive property between the plurality of first dielectric units CB1 and the plurality of second dielectric units CB2, between the plurality of second dielectric units CB2 and the plurality of third dielectric units CB3, and between the plurality of third dielectric units CB3 and the plurality of fourth dielectric units CB4.

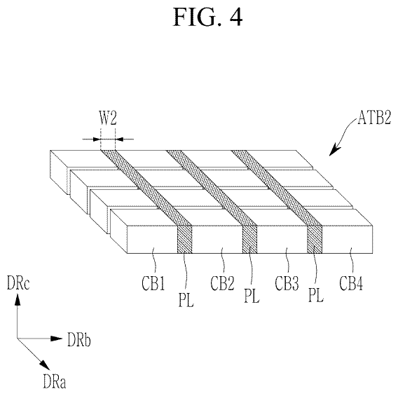

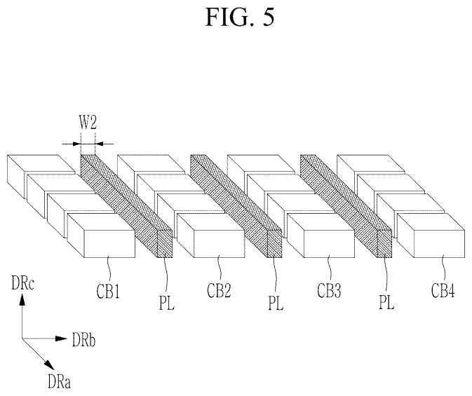

FIG. 4 illustrates a perspective view of an antenna unit according to another embodiment, and FIG. 5 illustrates an exploded perspective view of the antenna unit of FIG. 4 according to another embodiment.

Referring to FIG. 4 and FIG. 5, an antenna unit ATB2 according to the present embodiment is similar to the antenna unit ATB1 according to the embodiment illustrated in FIG. 1.

According to the present embodiment, the antenna unit ATB2 may include a plurality of first dielectric units CB1 arranged side by side in a first row along a first direction DRa, a plurality of second dielectric units CB2 arranged side by side in a second row along the first direction DRa, a plurality of third dielectric units CB3 arranged side by side in a third row along the first direction DRa, and a plurality of fourth dielectric units CB4 arranged side by side in a fourth row along the first direction DRa.

The first row of the first dielectric units CB1, the second row of the second dielectric units CB2, the third row of the third dielectric units CB3, and the fourth row of the fourth dielectric units CB4 may be sequentially arranged side by side along a second direction DRb.

The dielectric units CB1, CB2, CB3, and CB4 may have, e.g., a rectangular parallelepiped shape. The dielectric units CB1, CB2, CB3, and CB4 may include a ceramic material.

An interface layer PL extending along the first direction DRa is disposed between the first dielectric units CB1 and the second dielectric units CB2, between the second dielectric units CB2 and the third dielectric units CB3, and between the third dielectric units CB3 and the fourth dielectric units CB4. The interface layer PL may include a polymer material and may have an adhesive property.

A distance between the first dielectric units CB1 and the second dielectric units CB2, a distance between the second dielectric units CB2 and the third dielectric units CB3, and a distance between the third dielectric units CB3 and the fourth dielectric units CB4, arranged along the second direction DRb, may be equal to a second width W2 of the interface layer PL.

The second width W2 of the interface layer PL of the antenna unit ATB2 according to the present embodiment may be different from the first width W1 of the interface layer PL of the antenna unit ATB1 according to the embodiment illustrated in FIG. 1. For example, the second width W2 of the interface layer PL of the antenna unit ATB2 according to the present embodiment may be larger than the first width W1 of the interface layer PL of the antenna unit ATB1 according to the embodiment illustrated in FIG. 1

As such, the antenna unit ATB2 according to the present embodiment may include the dielectric units CB1, CB2, CB3, and CB4 arranged in an array form along the first and second directions DRa and DRb, and the interface layer PL disposed between the dielectric units CB1, CB2, CB3, and CB4. Accordingly, a performance of the antenna unit ATB2 may be improved while reducing a size of the antenna unit ATB2 compared to a case where the dielectric units CB1, CB2, CB3, and CB4 are arranged along only one direction.

Although the antenna unit ATB2 of the embodiment of FIG. 4 and FIG. 5 is illustrated as including four of each of the dielectric units CB1, CB2, CB3, and CB4 arranged along the first and second directions DRa and DRb, the embodiment is not limited thereto, and a number of each of the dielectric units arranged along the first and second directions DRa and DRb may vary.

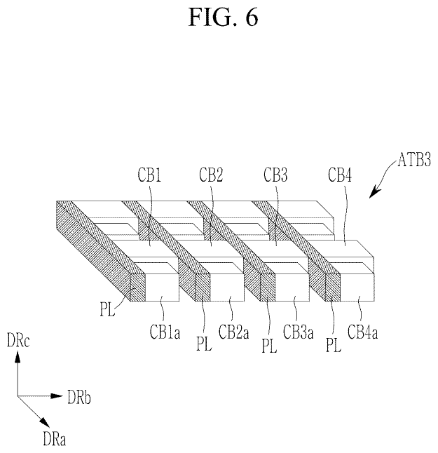

FIG. 6 illustrates a perspective view of an antenna unit according to another embodiment.

Referring to FIG. 6, an antenna unit ATB3 according to the present embodiment is similar to the antenna unit ATB1 according to the embodiment illustrated in FIG. 1 and the antenna unit ATB2 according to the embodiment illustrated in FIG. 4 and FIG. 5.

According to the present embodiment, the antenna unit ATB3 may include a plurality of first dielectric units CB1 and a plurality of fifth dielectric units CB1a alternately arranged side by side in a first row along a first direction DRa, a plurality of second dielectric units CB2 and a plurality of sixth dielectric units CB2a alternately arranged side by side in a second row along the first direction DRa, a plurality of third dielectric units CB3 and a plurality of seventh dielectric units CB3a alternately arranged side by side in a third row along the first direction DRa, and a plurality of fourth dielectric units CB4 and a plurality of eighth dielectric units CB4a alternately arranged side by side in a fourth row along the first direction DRa.

The first row of the first dielectric units CB1 and the fifth dielectric units CB1a, the second row of the second dielectric units CB2 and the sixth dielectric units CB2a, the third row of the third dielectric units CB3 and the seventh dielectric units CB3a, and the fourth row of the fourth dielectric units CB4 and the eighth dielectric units CB4a may be sequentially arranged side by side along a second direction DRb.

The dielectric units CB1, CB2, CB3, CB4, CB1a, CB2a, CB3a, and CB4a may have, e.g., a rectangular parallelepiped shape. The dielectric units CB1, CB2, CB3, CB4, CB1a, CB2a, CB3a, and CB4a may include a ceramic material.

Sizes of the fifth dielectric units CB1a, the sixth dielectric units CB2a, the seventh dielectric units CB3a, and the eighth dielectric units CB4a may be smaller than sizes of the first dielectric units CB1, the second dielectric units CB2, the third dielectric units CB3, and the fourth dielectric units CB4. For example, lengths of edges substantially parallel to the first direction DRa and the second direction DRb of the dielectric units CB1a, CB2a, CB3a, and CB4a may be smaller than lengths of edges substantially parallel to the first direction DRa and the second direction DRb of the dielectric units CB1, CB2, CB3, and CB4, and lengths of edges substantially parallel to a third direction DRc of the dielectric units CB1a, CB2a, CB3a, and CB4a may be substantially equal to lengths of edges substantially parallel to the third direction DRc of the plurality of dielectric units CB1, CB2, CB3, and CB4, but the present embodiment is not limited thereto.

The dielectric units CB1, CB2, CB3, and CB4 and the dielectric units CB1a, CB2a, CB3a, and CB4a having different sizes may transmit and receive electromagnetic signals of different bands, and accordingly, a range of wavelengths that can be transmitted and received by the antenna unit ATB3 may be varied.

Dielectric units having a same size as each other may be sequentially arranged side by side in rows along the second direction DRb. For example, the dielectric units CB1, CB2, CB3, and CB4 may be sequentially arranged side by side in some rows in the second direction DRb, and the dielectric units CB1a, CB2a, CB3a, and CB4a may be sequentially arranged side by side in other rows along the second direction DRb.

An interface layer PL extending along the first direction DRa may be disposed between adjacent dielectric units along the second direction DRb, may include a polymer material, and may have an adhesive property.

The interface layer PL extending along the first direction DRa may also be disposed on outside surfaces in the second direction DRb (i.e., the left sides as shown in FIG. 6) of the dielectric units CB1 and CB1a alternately arranged side by side in the first row along the first direction DRa to fix the dielectric units CB1 and CB1a in place.

As such, the antenna unit ATB3 according to the present embodiment may include the dielectric units CB1, CB2, CB3, CB4, CB1a, CB2a, CB3a, and CB4a arranged in an array form along the first and second directions DRa and DRb, and the interface layer PL disposed between the dielectric units CB1, CB2, CB3, CB4, CB1a, CB2a, CB3a, and CB4a. Accordingly, a performance of the antenna unit ATB3 may be improved while reducing a size of the antenna unit ATB3 compared to a case where the dielectric units CB1, CB2, CB3, CB4, CB1a, CB2a, CB3a, and CB4a are arranged along only one direction.

In addition, the antenna unit ATB3 according to the present embodiment may include the dielectric units CB1, CB2, CB3, and CB4 and the dielectric units CB1a, CB2a, CB3a, and CB4a having different sizes, thereby varying a range of wavelengths that can be transmitted and received by the antenna unit ATB3.

Although the antenna unit ATB3 of the embodiment of FIG. 6 is illustrated as including two of each of the dielectric units CB1, CB2, CB3, CB4, CB1a, CB2a, CB3a, and CB4a arranged along the first and second directions DRa and DRb, the embodiment is not limited thereto, and a number of each of the dielectric units arranged along the first and second directions DRa and DRb may vary.

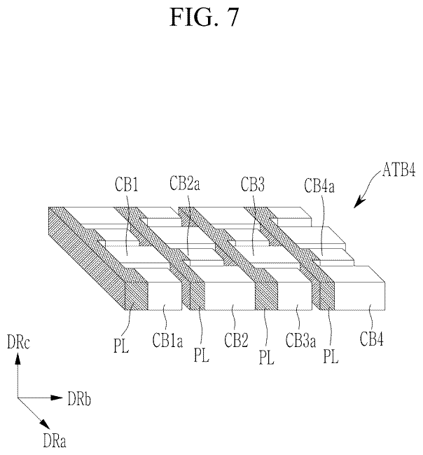

FIG. 7 illustrates a perspective view of an antenna unit according to another embodiment.

Referring to FIG. 7, an antenna unit ATB4 according to the present embodiment is similar to the antenna unit ATB1 according to the embodiment illustrated in FIG. 1, the antenna unit ATB2 according to the embodiment illustrated in FIG. 4 and FIG. 5, and the antenna unit ATB3 according to the embodiment illustrated in FIG. 6.

According to the present embodiment, the antenna unit ATB4 may include a plurality of first dielectric units CB1 and a plurality of fifth dielectric units CB1a alternately arranged side by side in a first row along a first direction DRa, a plurality of second dielectric units CB2 and a plurality of sixth dielectric units CB2a alternately arranged side by side in a second row along the first direction DRa, a plurality of third dielectric units CB3 and a plurality of seventh dielectric units CB3a alternately arranged side by side in a third row along the first direction DRa, and a plurality of fourth dielectric units CB4 and a plurality of eighth dielectric units CB4a alternately arranged side by side in a fourth row along the first direction DRa.

The first row of the first dielectric units CB1 and the fifth dielectric units CB1a, the second row of the second dielectric units CB2 and the sixth dielectric units CB2a, the third row of the third dielectric units CB3 and the seventh dielectric units CB3a, and the fourth row of the fourth dielectric units CB4 and the eighth dielectric units CB4a may be sequentially arranged side by side along a second direction DRb.

The dielectric units CB1, CB2, CB3, CB4, CB1a, CB2a, CB3a, and CB4a may have, e.g., a rectangular parallelepiped shape. The dielectric units CB1, CB2, CB3, CB4, CB1a, CB2a, CB3a, and CB4a may include a ceramic material.

Sizes of the fifth dielectric units CB1a, the sixth dielectric units CB2a, the seventh dielectric units CB3a, and the eighth dielectric units CB4a may be smaller than sizes of the first dielectric units CB1, the second dielectric units CB2, the third dielectric units CB3, and the fourth dielectric units CB4. For example, lengths of edges parallel to the first direction DRa and the second direction DRb of the dielectric units CB1a, CB2a, CB3a, and CB4a may be smaller than lengths of edges parallel to the first direction DRa and the second direction DRb of the dielectric units CB1, CB2, CB3, and CB4, and lengths of edges parallel to a third direction DRc of the dielectric units CB1a, CB2a, CB3a, and CB4a may be substantially equal to lengths of edges parallel to the third direction DRc of the plurality of dielectric units CB1, CB2, CB3, and CB4, but the present embodiment is not limited thereto.

Dielectric units having different sizes may be alternately arranged side by side in rows along the second direction DRb. For example, the dielectric units CB1, CB2a, CB3, and CB4a may be alternately arranged side by side in some rows along the second direction DRb, and the dielectric units CB1a, CB2, CB3a, and CB4 may be alternately arranged side by side in other rows along the second direction DRb.

The dielectric units CB1, CB2, CB3, and CB4 and the dielectric units CB1a, CB2a, CB3a, and CB4a having different sizes may transmit and receive electromagnetic signals of different bands, and accordingly, a range of wavelengths that can be transmitted and received by the antenna unit ATB4 may be varied.

An interface layer PL extending along the first direction DRa may be disposed between adjacent dielectric units along the second direction DRb, may include a polymer material, and may have an adhesive property.

The interface layer PL extending along the first direction DRa may also be disposed ion outside surfaces in the second direction DRb (i.e., the left sides as shown in FIG. 7) of the dielectric units CB1 and CB1a alternately arranged side by side in the first row along the first direction DRa to fix the dielectric units CB1 and CB1a in place.

The interface layer PL may not have a constant thickness along the first direction DRa, and may protrude in the second direction DRb toward the dielectric units CB1a, CB2a, CB3a, and CB4a having a smaller size than the dielectric units CB1, CB2, CB3, and CB4, and accordingly, the dielectric units CB1, CB2, CB3, and CB4 and the dielectric units CB1a, CB2a, CB3a, and CB4a having different sizes may be fixed together by the interface layer PL.

As such, the antenna unit ATB4 according to the present embodiment may include the dielectric units CB1, CB2, CB3, CB4, CB1a, CB2a, CB3a, and CB4a arranged in an array form along the first and second directions DRa and DRb, and the interface layer PL disposed between the dielectric units CB1, CB2, CB3, CB4, CB1a, CB2a, CB3a, and CB4a. Accordingly, a performance of the antenna unit ATB4 may be improved while reducing a size of the antenna unit ATB4 compared to a case where the dielectric units CB1, CB2, CB3, CB4, CB1a, CB2a, CB3a, and CB4a are arranged along only one direction.

In addition, the antenna unit ATB4 according to the present embodiment may include the dielectric units CB1, CB2, CB3, and CB4 and the dielectric units CB1a, CB2a, CB3a, and CB4a having different sizes, thereby varying a range of wavelengths that can be transmitted and received by the antenna unit ATB4.

Although the antenna unit ATB4 of the embodiment of FIG. 7 is illustrated as including two of each of the dielectric units CB1, CB2, CB3, CB4, CB1a, CB2a, CB3a, and CB4a arranged along the first and second directions DRa and DRb, the embodiment is not limited thereto, and a number of each of the dielectric units arranged along the first and second directions DRa and DRb may vary.

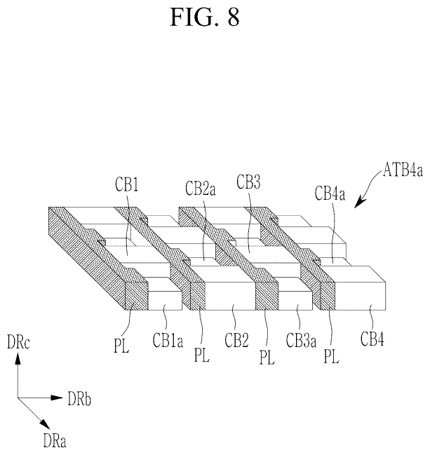

FIG. 8 illustrates a perspective view of an antenna unit according to another embodiment.

Referring to FIG. 8, an antenna unit ATB4a according to the present embodiment is similar to the antenna unit ATB1 according to the embodiment illustrated in FIG. 1, the antenna unit ATB2 according to the embodiment illustrated in FIG. 4 and FIG. 5, the antenna unit ATB3 according to the embodiment illustrated in FIG. 6, and the antenna unit ATB4 according to the embodiment illustrated in FIG. 7.

According to the present embodiment, the antenna unit ATB4a may include a plurality of first dielectric units CB1 and a plurality of fifth dielectric units CB1a alternately arranged side by side in a first row along a first direction DRa, a plurality of second dielectric units CB2 and a plurality of sixth dielectric units CB2a alternately arranged side by side in a second row along the first direction DRa, a plurality of third dielectric units CB3 and a plurality of seventh dielectric units CB3a alternately arranged side by side in a third row along the first direction DRa, and a plurality of fourth dielectric units CB4 and a plurality of eighth dielectric units CB4a alternately arranged side by side in a fourth row along the first direction DRa.

The first row of the first dielectric units CB1 and the fifth dielectric units CB1a, the second row of the second dielectric units CB2 and the sixth dielectric units CB2a, the third row of the third dielectric units CB3 and the seventh dielectric units CB3a, and the fourth row of the fourth dielectric units CB4 and the eighth dielectric units CB4a may be sequentially arranged side by side along a second direction DRb.

The dielectric units CB1, CB2, CB3, CB4, CB1a, CB2a, CB3a, and CB4a may have, e.g., a rectangular parallelepiped shape. The dielectric units CB1, CB2, CB3, CB4, CB1a, CB2a, CB3a, and CB4a may include a ceramic material.

Sizes of the fifth dielectric units CB1a, the sixth dielectric units CB2a, the seventh dielectric units CB3a, and the eighth dielectric units CB4a may be smaller than sizes of the first dielectric units CB1, the second dielectric units CB2, the third dielectric units CB3, and the fourth dielectric units CB4. For example, lengths of edges parallel to the first direction DRa and the second direction DRb of the dielectric units CB1a, CB2a, CB3a, and CB4a may be smaller than lengths of edges parallel to the first direction DRa and the second direction DRb of the dielectric units CB1, CB2, CB3, and CB4, and lengths of edges parallel to the third direction DRc of the dielectric units CB1a, CB2a, CB3a, and CB4a may also be smaller than lengths of edges parallel to the third direction DRc of the plurality of dielectric units CB1, CB2, CB3, and CB4, but the present embodiment is not limited thereto.

Dielectric units having different sizes may be alternately arranged side by side in rows along the second direction DRb. For example, the dielectric units CB1, CB2a, CB3, and CB4a may be alternately arranged side by side in some rows along the second direction DRb, and the dielectric units CB1a, CB2, CB3a, and CB4 may be alternately arranged side by side in other rows along the second direction DRb.

The dielectric units CB1, CB2, CB3, and CB4 and the dielectric units CB1a, CB2a, CB3a, and CB4a having different sizes may transmit and receive electromagnetic signals of different bands, and accordingly, a range of wavelengths that can be transmitted and received by the antenna unit ATB4a may be varied.

The interface layer PL extending along the first direction DRa may be disposed between adjacent dielectric units along the second direction DRb, may include a polymer material, and may have an adhesive property.

The interface layer PL extending along the first direction DRa may also be disposed on outside surfaces in the second direction DRb (i.e., the left sides as shown in FIG. 8) of the dielectric units CB1 and CB1a alternately arranged side by side in the first row along the first direction DRa to fix the dielectric units CB1 and CB1a in place.

The interface layer PL may not have a constant thickness along the first direction DRa, and may protrude in the second direction DRb toward the dielectric units CB1a, CB2a, CB3a, and CB4a having a smaller size than the dielectric units CB1, CB2, CB3, and CB4, and accordingly, the dielectric units CB1, CB2, CB3, and CB4 and the dielectric units CB1a, CB2a, CB3a, and CB4a having different sizes may be fixed together.

As such, the antenna unit ATB4a according to the present embodiment may include the dielectric units CB1, CB2, CB3, CB4, CB1a, CB2a, CB3a, and CB4a arranged in an array form along the first and second directions DRa and DRb, and an interface layer PL disposed between the dielectric units CB1, CB2, CB3, CB4, CB1a, CB2a, CB3a, and CB4a. Accordingly, a performance of the antenna unit ATB4a may be improved while reducing a size of the antenna unit ATB4a compared to a case where the dielectric units CB1, CB2, CB3, CB4, CB1a, CB2a, CB3a, and CB4a are arranged along only one direction.

In addition, the antenna unit ATB4a according to the present embodiment may include the dielectric units CB1, CB2, CB3, and CB4 and the dielectric units CB1a, CB2a, CB3a, and CB4a having different sizes, thereby varying a range of wavelengths that can be transmitted and received by the antenna unit ATB4a.

Although the antenna unit ATB4a of the embodiment of FIG. 8 is illustrated as including two of each of the dielectric units CB1, CB2, CB3, CB4, CB1a, CB2a, CB3a, and CB4a arranged along the first and second directions DRa and DRb, the embodiment is not limited thereto, and a number of each of the dielectric units arranged along the first and second directions DRa and DRb may vary.

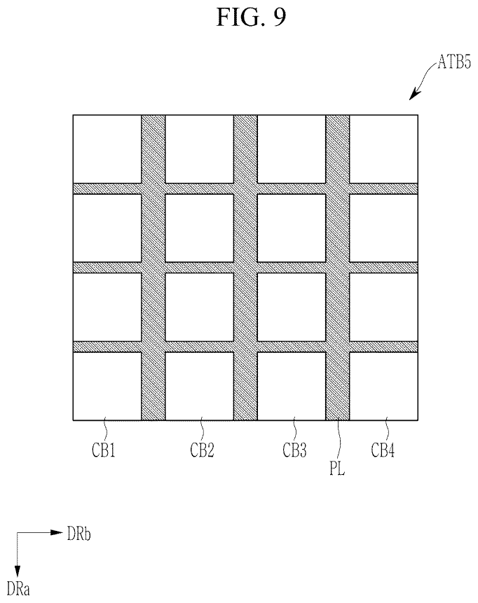

FIG. 9 illustrates a top plan view of an antenna unit according to another embodiment.

Referring to FIG. 9, an antenna unit ATB5 according to the present embodiment is similar to the antenna units ATB1 and ATB2 according to the embodiments illustrated in FIGS. 1 and 4.

According to the present embodiment, the antenna unit ATB5 may include a plurality of first dielectric units CB1 arranged side by side in a first row along a first direction DRa, a plurality of second dielectric units CB2 arranged side by side in a second row along the first direction DRa, a plurality of third dielectric units CB3 arranged side by side in a third row along the first direction DRa, and a plurality of fourth dielectric units CB4 arranged side by side in a fourth row along the first direction DRa.

The first row of the first dielectric units CB1, the second row of the second dielectric units CB2, the third row of the third dielectric units CB3, and the fourth row of the fourth dielectric units CB4 may be sequentially arranged side by side along a second direction DRb.

The dielectric units CB1, CB2, CB3, and CB4 may have, e.g., a rectangular parallelepiped shape. The dielectric units CB1, CB2, CB3, and CB4 may include a ceramic material.

An interface layer PL disposed along the first direction DRa and the second direction DRb is disposed between the dielectric units CB1, CB2, CB3, and CB4. Unlike in the antenna units ATB1 and ATB1 according to the embodiments illustrated in FIGS. 1 and 4, a binding force between the dielectric units CB1, CB2, CB3, and CB4 may be increased by forming the interface layer PL along the first direction DRa and the second direction DRb.

As such, the antenna unit ATB5 according to the present embodiment may include the dielectric units CB1, CB2, CB3, and CB4 arranged in an array form along the first and second directions DRa and DRb, and the interface layer PL disposed between the dielectric units CB1, CB2, CB3, and CB4 along the first and second directions DRa and DRb. Accordingly, a performance of the antenna unit ATB5 may be improved while reducing a size of the antenna unit ATB5 compared to a case where the dielectric units CB1, CB2, CB3, and CB4 are arranged along only one direction.

Although the antenna unit ATB5 of the embodiment of FIG. 9 is illustrated as including four of each of the dielectric units CB1, CB2, CB3, and CB4 arranged along the first and second directions DRa and DRb, the embodiment is not limited thereto, and a number of each of the dielectric units arranged along the first and second directions DRa and DRb may vary.

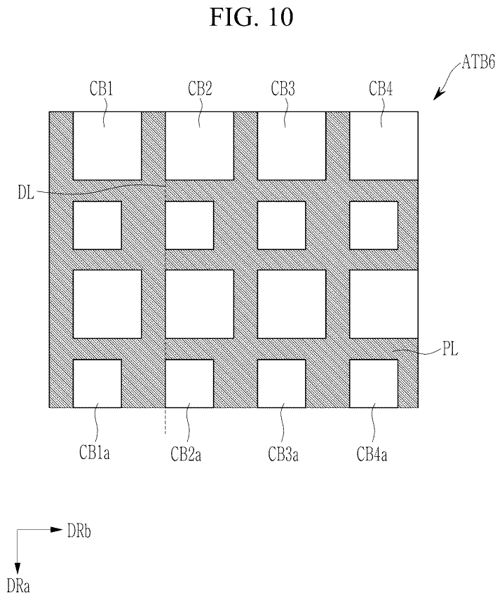

FIG. 10 illustrates a top plan view of an antenna unit according to another embodiment.

Referring to FIG. 10, an antenna unit ATB6 according to the present embodiment is similar to the antenna unit ATB3 according to the embodiment illustrated in FIG. 6.

According to the present embodiment, the antenna unit ATB6 may include a plurality of first dielectric units CB1 and a plurality of fifth dielectric units CB1a alternately arranged side by side in a first row along the first direction DRa, a plurality of second dielectric units CB2 and a plurality of sixth dielectric units CB2a alternately arranged side by side in a second row along the first direction DRa, a plurality of third dielectric units CB3 and a plurality of seventh dielectric units CB3a alternately arranged side by side in a third row along the first direction DRa, and a plurality of fourth dielectric units CB4 and a plurality of eighth dielectric units CB4a alternately arranged side by side in a fourth row along the first direction DRa.

The dielectric units CB1, CB2, CB3, CB4, CB1a, CB2a, CB3a, and CB4a may have, e.g., a rectangular parallelepiped shape. The dielectric units CB1, CB2, CB3, CB4, CB1a, CB2a, CB3a, and CB4a may include a ceramic material.

Sizes of the fifth dielectric units CB1a, the sixth dielectric units CB2a, the seventh dielectric units CB3a, and the eighth dielectric units CB4a may be smaller than sizes of the first dielectric units CB1, the second dielectric units CB2, the third dielectric units CB3, and the fourth dielectric units CB4.

The dielectric units CB1, CB2, CB3, and CB4 and the dielectric units CB1a, CB2a, CB3a, and CB4a having different sizes may transmit and receive electromagnetic signals of different bands, and accordingly, a range of wavelengths that can be transmitted and received by the antenna unit ATB3 may be varied.

Dielectric units having a same size as each other may be sequentially arranged side by side in rows along the second direction DRb. For example, the dielectric units CB1, CB2, CB3, and CB4 may be sequentially arranged side by side in some rows along the second direction DRb, and the dielectric units CB1a, CB2a, CB3a, and CB4a may be sequentially arranged side by side in other rows along the second direction DRb.

Dielectric units having different sizes may be arranged in the rows in the first direction DRa so that one side of each of the dielectric units having different sizes is in contact with an arrangement line DL along the first direction DRa.

Unlike in the antenna unit ATB3 according to the embodiment illustrated in FIG. 6, in accordance with the antenna unit ATB6 according to the present embodiment, the interface layer PL extending along not only the first direction DRa but also the second direction DRb may be disposed between the dielectric units adjacent to each other. As such, a binding force between the dielectric units CB1, CB2, CB3, CB4, CB1a, CB2a, CB3a, and CB4a may be increased by forming the interface layer PL along the first direction DRa and the second direction DRb.

As such, the antenna unit ATB6 according to the present embodiment may include the dielectric units CB1, CB2, CB3, CB4, CB1a, CB2a, CB3a, and CB4a arranged in an array form along the first and second directions DRa and DRb, and the interface layer PL disposed between the dielectric units CB1, CB2, CB3, CB4, CB1a, CB2a, CB3a, and CB4a along the first and second directions DRa and DRb. Accordingly, a performance of the antenna unit ATB6 may be improved while reducing a size of the antenna unit ATB6 compared to a case where the dielectric units CB1, CB2, CB3, CB4, CB1a, CB2a, CB3a, and CB4a are arranged along only one direction.

In addition, the antenna unit ATB6 according to the present embodiment may include the dielectric units CB1, CB2, CB3, and CB4 and the dielectric units CB1a, CB2a, CB3a, and CB4a having different sizes, thereby varying a range of wavelengths that can be transmitted and received by the antenna unit ATB6.

According to the embodiment of FIG. 10, although the antenna unit ATB6 is illustrated as including two of each of the dielectric units CB1, CB2, CB3, CB4, CB1a, CB2a, CB3a, and CB4a arranged along the first and second directions DRa and DRb, the embodiment is not limited thereto, and a number of each of the dielectric units arranged along the first and second directions DRa and DRb may vary.

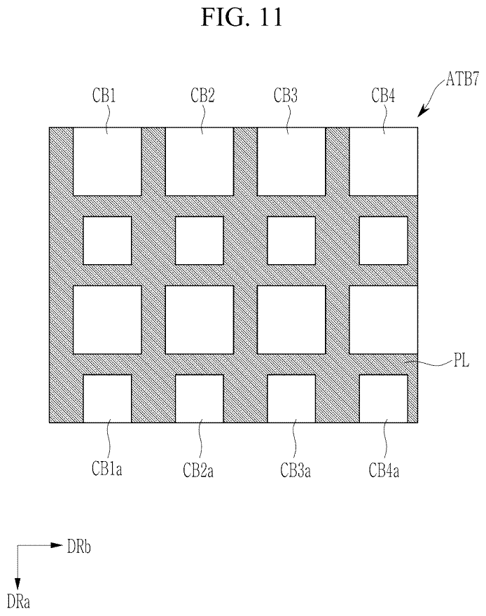

FIG. 11 illustrates a top plan view of an antenna unit according to another embodiment.

Referring to FIG. 11, an antenna unit ATB7 according to the present embodiment is similar to the antenna units ATB3 and ATB6 according to the embodiments illustrated in FIGS. 6 and 9.

According to the present embodiment, the antenna unit ATB7 may include a plurality of first dielectric units CB1 and a plurality of fifth dielectric units CB1a alternately arranged side by side in a first row along the first direction DRa, a plurality of second dielectric units CB2 and a plurality of sixth dielectric units CB2a alternately arranged side by side in a second row along the first direction DRa, a plurality of third dielectric units CB3 and a plurality of seventh dielectric units CB3a alternately arranged side by side in a third row along the first direction DRa, and a plurality of fourth dielectric units CB4 and a plurality of eighth dielectric units CB4a alternately arranged side by side in a fourth row along the first direction DRa.

The dielectric units CB1, CB2, CB3, CB4, CB1a, CB2a, CB3a, and CB4a may have, e.g., a rectangular parallelepiped shape. The dielectric units CB1, CB2, CB3, CB4, CB1a, CB2a, CB3a, and CB4a may include a ceramic material.

Sizes of the fifth dielectric units CB1a, the sixth dielectric units CB2a, the seventh dielectric units CB3a, and the eighth dielectric units CB4a may be smaller than sizes of the first dielectric units CB1, the second dielectric units CB2, the third dielectric units CB3, and the fourth dielectric units CB4.

The dielectric units CB1, CB2, CB3, and CB4 and the dielectric units CB1a, CB2a, CB3a, and CB4a having different sizes may transmit and receive electromagnetic signals of different bands, and accordingly, a range of wavelengths that can be transmitted and received by the antenna unit ATB7 may be varied.

Dielectric units having a same size as each other may be sequentially arranged side by side in rows along the second direction DRb. For example, the dielectric units CB1, CB2, CB3, and CB4 may be sequentially arranged side by side in some rows along the second direction DRb, and the dielectric units CB1a, CB2a, CB3a, and CB4a may be sequentially arranged side by side in even rows along the second direction DRb.

Centers of the dielectric units having different sizes may be aligned with each other along the first direction DRa.

Unlike in the antenna unit ATB3 according to the embodiment illustrated in FIG. 6, in accordance with the antenna unit ATB7 according to the present embodiment, the interface layer PL extending along not only the first direction DRa but also the second direction DRb may be disposed between the dielectric units adjacent to each other. As such, a binding force between the dielectric units CB1, CB2, CB3, CB4, CB1a, CB2a, CB3a, and CB4a may be increased by forming the interface layer PL along the first direction DRa and the second direction DRb.

As such, the antenna unit ATB7 according to the present embodiment may include the dielectric units CB1, CB2, CB3, CB4, CB1a, CB2a, CB3a, and CB4a arranged in an array form along the first and second directions DRa and DRb, and an interface layer PL disposed between the dielectric units CB1, CB2, CB3, CB4, CB1a, CB2a, CB3a, and CB4a along the first and second directions DRa and DRb. Accordingly, performance of the antenna unit ATB7 may be improved while reducing a size of the antenna unit ATB7 compared to a case where the dielectric units CB1, CB2, CB3, CB4, CB1a, CB2a, CB3a, and CB4a of the antenna unit ATB7 are arranged along only one direction.

In addition, the antenna unit ATB7 according to the present embodiment may include the dielectric units CB1, CB2, CB3, and CB4 and the dielectric units CB1a, CB2a, CB3a, and CB4a having different sizes, thereby varying a range of wavelengths that can be transmitted and received by the antenna unit ATB7.

According to the embodiment of FIG. 11, although the antenna unit ATB7 is illustrated as including two of each of the dielectric units CB1, CB2, CB3, CB4, CB1a, CB2a, CB3a, and CB4a arranged along the first and second directions DRa and DRb, the embodiment is not limited thereto, and a number of each of the dielectric units arranged along the first and second directions DRa and DRb may vary.

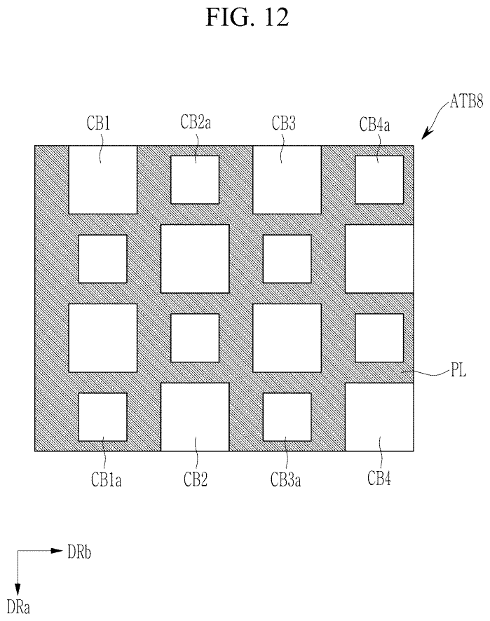

FIG. 12 illustrates a top plan view of an antenna unit according to another embodiment.

Referring to FIG. 12, an antenna unit ATB8 according to the present embodiment is similar to the antenna units ATB4 and ATB4a according to the embodiments illustrated in FIGS. 7 and 8.

According to the present embodiment, the antenna unit ATB8 may include a plurality of first dielectric units CB1 and a plurality of fifth dielectric units CB1a alternately arranged side by side in a first row along the first direction DRa, a plurality of second dielectric units CB2 and a plurality of sixth dielectric units CB2a alternately arranged side by side in a second row along the first direction DRa, a plurality of third dielectric units CB3 and a plurality of seventh dielectric units CB3a alternately arranged side by side in a third row along the first direction DRa, and a plurality of fourth dielectric units CB4 and a plurality of eighth dielectric units CB4a alternately arranged side by side in a fourth row along the first direction DRa.

The dielectric units CB1, CB2, CB3, CB4, CB1a, CB2a, CB3a, and CB4a may have, e.g., a rectangular parallelepiped shape. The dielectric units CB1, CB2, CB3, CB4, CB1a, CB2a, CB3a, and CB4a may include a ceramic material.

Sizes of the fifth dielectric units CB1a, the sixth dielectric units CB2a, the seventh dielectric units CB3a, and the eighth dielectric units CB4a may be smaller than sizes of the first dielectric units CB1, the second dielectric units CB2, the third dielectric units CB3, and the fourth dielectric units CB4.

Dielectric units having different sizes may be alternately arranged side by side in rows along the second direction DRb. For example, the dielectric units CB1, CB2a, CB3, and CB4a may be alternately arranged side by side in some rows along the second direction DRb, and the dielectric units CB1a, CB2, CB3a, and CB4 may be alternately arranged side by side in other rows along the second direction DRb.

The dielectric units CB1, CB2, CB3, and CB4 and the dielectric units CB1a, CB2a, CB3a, and CB4a having different sizes may transmit and receive electromagnetic signals of different bands, and accordingly, a range of wavelengths that can be transmitted and received by the antenna unit ATB4 may be varied.

Unlike in the antenna units ATB4 and ATB4a according to the embodiments illustrated in FIGS. 7 and 8, in accordance with the antenna unit ATB8 according to the present embodiment, an interface layer PL extending along not only the first direction DRa but also along the second direction DRb may be disposed between the dielectric units adjacent to each other. As such, a binding force between the dielectric units CB1, CB2, CB3, CB4, CB1a, CB2a, CB3a, and CB4a may be increased by forming the interface layer PL along the first direction DRa and the second direction DRb.

As such, the antenna unit ATB8 according to the present embodiment may include the dielectric units CB1, CB2, CB3, CB4, CB1a, CB2a, CB3a, and CB4a arranged in an array form along the first and second directions DRa and DRb, and the interface layer PL disposed between the dielectric units CB1, CB2, CB3, CB4, CB1a, CB2a, CB3a, and CB4a along the first and second directions DRa and DRb. Accordingly, a performance of the antenna unit ATB8 may be improved while reducing a size of the antenna unit ATB8 compared to a case where the dielectric units CB1, CB2, CB3, CB4, CB1a, CB2a, CB3a, and CB4a of the antenna unit ATB8 are arranged along only one direction.

In addition, the antenna unit ATB8 according to the present embodiment may include the dielectric units CB1, CB2, CB3, and CB4 and the dielectric units CB1a, CB2a, CB3a, and CB4a having different sizes, thereby varying a range of wavelengths that can be transmitted and received by the antenna unit ATB8.

According to the embodiment of FIG. 12, although the antenna unit ATB8 is illustrated as including two of each of the dielectric units CB1, CB2, CB3, CB4, CB1a, CB2a, CB3a, and CB4a arranged along the first and second directions DRa and DRb, the embodiment is not limited thereto, and a number of each of the dielectric units arranged along the first and second directions DRa and DRb may vary.

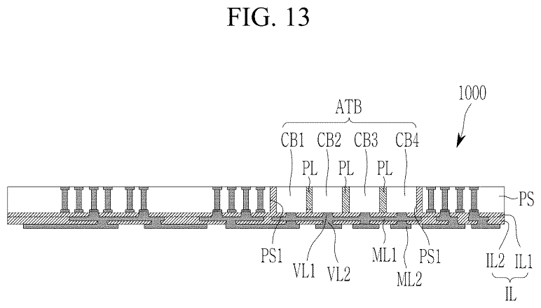

FIG. 13 illustrates a cross-sectional view showing a substrate having an embedded antenna according to an embodiment.

Referring to FIG. 13, a substrate 1000 with an embedded antenna according to an embodiment may include a substrate PS having an opening PS1, an antenna unit ATB embedded in the opening PS1 of the substrate PS, an insulating layer IL disposed on one side of the substrate PS, a plurality of via layers VL1 and VL2 formed in the insulating layer IL, and a plurality of wiring layers ML1 and ML2 connected to the via layers VL1 and VL2.

The substrate PS may be a core substrate, and may include a liquid crystal polymer resin impregnated with a reinforcing material. The liquid crystal polymer resin may be a soluble type formed by dissolving a liquid crystal polymer in a solvent, and the solvent may include at least one selected from a group consisting of N-methylpyrrolidone (NMP), p-chlorophenol (PCP), dimethylformamide (DMF), or dimethylacetamide (DMAc). The reinforcing material may include any one or any combination of any two or more of glass woven fiber, liquid crystal polymer fiber, liquid crystal polymer non-woven fabric, hybrid fiber, and aramid reinforcement (non-woven or fabric), and may further include inorganic filler including silica (SiO₂) and alumina (Al₂O₃).

The antenna unit ATB may include the dielectric units CB1, CB2, CB3, and CB4, and the interface layer PL disposed between the dielectric units CB1, CB2, CB3, and CB4. The antenna unit ATB may be any one of the previously described antenna units ATB1, ATB2, ATB3, ATB4, ATB4a, ATB5, ATB6, ATB7, and ATB8.

The dielectric units CB1, CB2, CB3, and CB4 may have, e.g., a rectangular parallelepiped shape. The dielectric units CB1, CB2, CB3, and CB4 may include a ceramic material, and a dielectric constant of the dielectric units CB1, CB2, CB3, and CB4 may be greater than a dielectric constant of the substrate PS.

The interface layer PL may include a polymer, and may have an adhesive property. The dielectric units CB1, CB2, CB3, and CB4 may be fixed to each other by the interface layer PL.

The antenna unit ATB may be supplied with power through the via layers VL1 and VL2 formed in the insulating layer IL and some of the wiring layers ML1 and ML2 connected to the via layers VL1 and VL2.

The insulating layer IL may include a first insulating layer IL1 and a second insulating layer IL2, and may include one or more additional insulating layers in addition to the first insulating layer IL1 and the second insulating layer 1L2.

The dielectric units CB1, CB2, CB3, and CB4 of the antenna unit ATB may receive electrical signals through a feeding unit, and a resonance at a certain frequency may occur inside the dielectric units CB1, CB2, CB3, and CB4 to which the electrical signals are applied, and an RF signal may be transmitted and received depending on a resonance frequency of the antenna unit ATB.

Resonance frequencies inside the dielectric units CB1, CB2, CB3, and CB4 may be determined from the dielectric constant of the dielectric units CB1, CB2, CB3, and CB4 and an axial propagation constant parallel to an edge of each side of the dielectric units CB1, CB2, CB3, and CB4.

When the resonance frequency inside the dielectric units CB1, CB2, CB3, and CB4 is constant, a size of each of the dielectric units CB1, CB2, CB3, and CB4 is proportional to (e)^{-1/2}, when the dielectric constant of each of the dielectric units CB1, CB2, CB3, and CB4 is e. Accordingly, the size of the antenna unit ATB may be reduced by increasing the dielectric constant of each of the dielectric units CB1, CB2, CB3, and CB4.

In accordance with the substrate 1000 with an embedded antenna according to an embodiment, a performance degradation of the antenna unit ATB may be prevented without increasing a thickness of the substrate PS in which the antenna unit ATB is embedded and without increasing a volume of the antenna unit STB by embedding the antenna unit ATB including the dielectric units CB1, CB2, CB3, and CB4 having a higher dielectric constant than a dielectric constant of the substrate PS and the interface layer PL in the substrate PS.

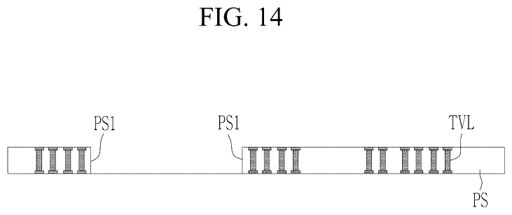

Now, a manufacturing method of a substrate with an embedded antenna will be described with reference to FIG. 14 to FIG. 23 together with FIG. 13. FIG. 14 to FIG. 23 illustrate cross-sectional views showing a manufacturing method of a substrate with an embedded antenna according to an embodiment.

Referring to FIG. 14, a plurality of through via layers TVL and an opening PS1 are formed in a substrate PS. Electrical connection between layers formed above and below the substrate PS is possible through the through via layers TVL.

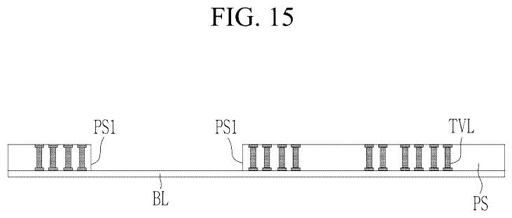

Referring to FIG. 15, a base layer BL is attached to one surface of the substrate PS. The base layer BL may temporarily support the substrate PS, and may later be detached from the substrate PS as described below.

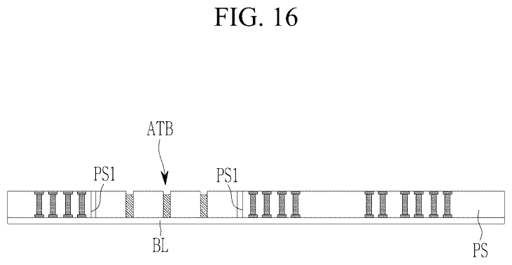

Referring to FIG. 16, an antenna unit ATB is disposed in the opening PS1 of the substrate PS.

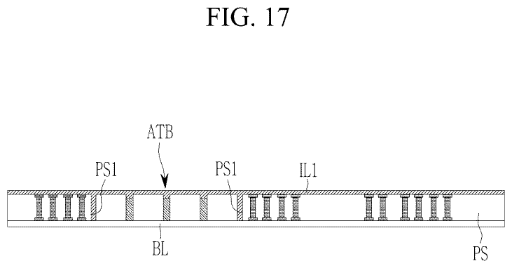

Referring to FIG. 17, the antenna ATB may be stably maintained in the opening PS1 of the substrate PS by forming a first insulating layer IL1 on the substrate PS and the antenna unit ATB.

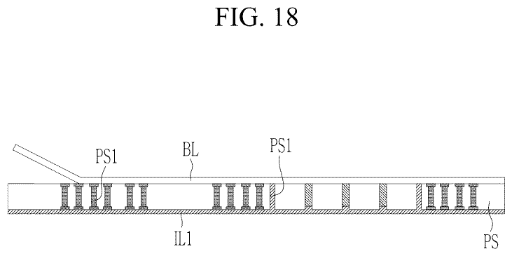

As illustrated in FIG. 18, the base layer BL is removed from the substrate PS.

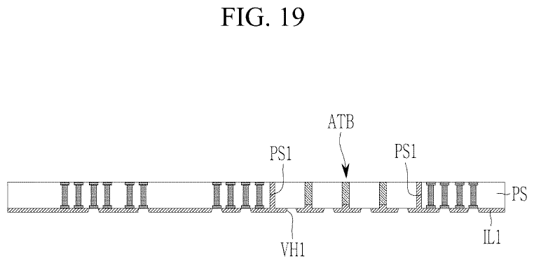

As illustrated in FIG. 19, a plurality of first via holes VH1 are formed in the first insulating layer IL1 disposed on the substrate PS and the antenna unit ATB. Some of the first via holes VH1 may be formed to overlap the antenna unit ATB.

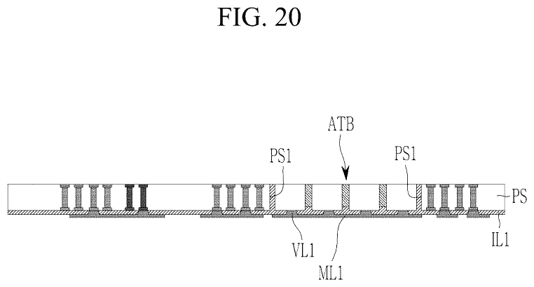

Referring to FIG. 20, a plurality of first via layers VL1 are formed in the first via holes VH1 formed in the first insulating layer IL1, and a plurality of first wiring layers ML1 connected to the first via layers VL1 are formed.

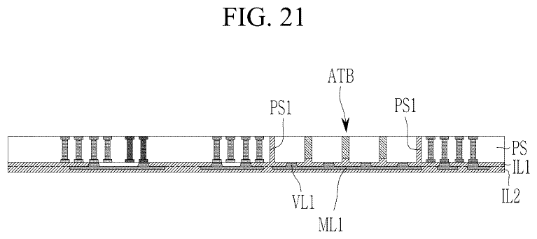

Referring to FIG. 21, a second insulating layer IL2 is formed on the first wiring layers ML1.

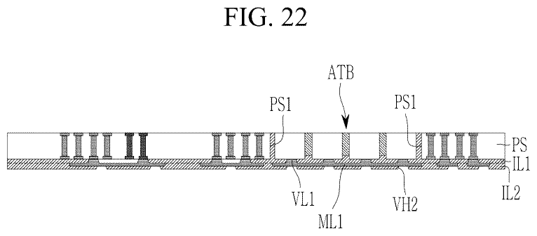

As illustrated in FIG. 22, a plurality of second via holes VH2 are formed in the second insulating layer IL2. Some of the second via holes VH2 may be formed to overlap the first via holes VH1 overlapping the antenna unit ATB.

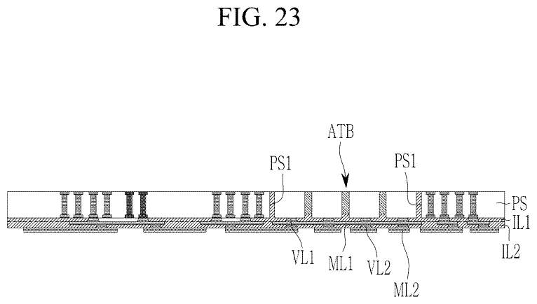

As illustrated in FIG. 23, a substrate 1000 having an embedded antenna according to an embodiment as illustrated in FIG. 13 may be formed by forming a plurality of second via layers VL2 in the second via holes VH2 formed in the second insulating layer IL2, and forming a plurality of second wiring layers ML2 connected to the second via layers VL2.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and are not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An antenna comprising:
a plurality of dielectric units arranged along a first direction and a second direction different from the first direction; and
an interface layer disposed between the dielectric units and attached to two adjacent dielectric units among the plurality of dielectric units.

2. The antenna of claim 1, wherein the dielectric units are arranged in an array form along the first direction and the second direction.

3. The antenna of claim 2, wherein the dielectric units comprise a ceramic material.

4. The antenna of claim 3, wherein the interface layer has an adhesive property.

5. The antenna of claim 4, wherein the interface layer comprises a polymer.

6. The antenna of claim 2, wherein the dielectric units have a rectangular parallelepiped shape.

7. The antenna of claim 6, wherein all of the dielectric units have substantially a same size.

8. The antenna of claim 6, wherein the dielectric units comprise a plurality of first dielectric units each having a first size, and a plurality of second dielectric units each having a second size different from the first size.

9. The antenna of claim 8, wherein the first dielectric units and the second dielectric units are alternately disposed in rows along the first direction.

10. The antenna of claim 9, wherein one side of each of the first dielectric units and the second dielectric units in each of the rows is aligned in the second direction with an imaginary line along the first direction.

11. The antenna of claim 9, wherein the first dielectric units and the second dielectric units are also alternately disposed in rows along the second direction.

12. The antenna of claim 1, wherein the interface layer is disposed between dielectric units adjacent to each other along the second direction among the dielectric units, and has a shape extending along the first direction.

13. The antenna of claim 12, wherein the interface layer comprises a portion disposed between dielectric units adjacent to each other along the first direction among the dielectric units and having a shape extending along the second direction.

14. An antenna embedded substrate comprising:
a substrate comprising a plurality of through via layers and an opening;
an antenna disposed in the opening of the substrate, the antenna comprising a plurality of dielectric units arranged along a first direction and a second direction different from the first direction, and an interface layer disposed between the dielectric units and attached to two adjacent dielectric units among the dielectric units;
an insulating layer disposed on a first surface of the substrate;
a plurality of via layers disposed in the insulating layer; and
a plurality of wiring layers connected to the via layers.

15. The antenna embedded substrate of claim 14, wherein a dielectric constant of each of the dielectric units is greater than a dielectric constant of the substrate.

16. The antenna embedded substrate of claim 15, wherein the dielectric units comprise a ceramic material.

17. The antenna embedded substrate of claim 16, wherein the interface layer has an adhesive property.

18. The antenna embedded substrate of claim 17, wherein the interface layer comprises a polymer.

19. The antenna embedded substrate of claim 14, wherein the interface layer is disposed between dielectric units adjacent to each other along the second direction among the dielectric units, and has a shape extending along the first direction.

20. The antenna embedded substrate of claim 19, wherein the interface layer comprises a portion disposed between dielectric units adjacent to each other along the first direction among the dielectric units and having a shape extending along the second direction.
